(19) United States
(12) Patent Application Publication
(10) Pub. No.: US 2011/0119547 A1
(43) Pub. Date: May 19, 2011

(54) METHOD AND APPARATUS FOR DOWNLOADING FILES USING BOTH DIGITAL BROADCASTING AND INTERNET-BASED TRANSMISSION

(75) Inventors: Sunghwan KIM, Seoul (KR); Sangjin KIM, Seoul (KR); Jaehun CHA, Seoul (KR); Hakjoo LEE, Seoul (KR)

(73) Assignee: SEOUL BROADCASTING SYSTEM CO., LTD., Seoul (KR)

(21) Appl. No.: 12/775,135

(22) Filed: May 6, 2010

(30) Foreign Application Priority Data
Nov. 17, 2009 (KR) 10-2009-0111159

(51) Int. Cl. H04L 1/18; G06F 11/14

(52) U.S. Cl. 714/748; 714/E11.117

(57) ABSTRACT

Disclosed herein is a method and apparatus for downloading files using both digital broadcasting and Internet-based transmission. In the method, a file is divided into uniformly sized blocks and transmitting the blocks via digital broadcasting. In a case where blocks which failed to be received are present and retransmission of the blocks is required, if a specific block requiring retransmission must be retransmitted to a number of receivers which are equal to or greater than a predetermined number of receivers from among a total number of receivers, the specific block is retransmitted via digital broadcasting, whereas if the specific block must be retransmitted to a number of receivers which are less than the predetermined number of receivers, the specific block is retransmitted over an Internet.

### BACKGROUND OF THE INVENTION

1. Field of the Invention

The present invention relates, in general, to the downloading of files, and, more particularly, to the downloading of files using both digital broadcasting and Internet-based transmission.

2. Description of the Related Art

Among all communication methods, a broadcasting network is the most efficient network capable of simultaneously transferring the same large-capacity data to a plurality of devices, but is disadvantageous because it is a means of one-way communication. That is, digital broadcasting enables the same large-capacity data to be simultaneously transferred to a plurality of receivers, but there is no method for retransmitting data when reception errors occur in some of the receivers. In contrast, the Internet enables parts which failed to be received to be completely transferred via retransmission when transmission errors occur, but it is inefficient when the same data is simultaneously transferred to a plurality of receivers.

Broadcasting networks have to date been mainly used to transfer video and audio data. However, recently, broadcasting networks have started to be used by broadcasting media to transmit large-capacity data such as files. In practice, various types of technology for downloading files via terrestrial broadcasting have been proposed. In some fields, such technology has been actually used. A technology standard called Software Download Data Service (SDDS) was developed by the Advanced Television Systems Committee (ATSC), and enables software such as receiver firmware to be downloaded using receivers. Further, a technology standard related to Non-Real Time (NRT) was developed by the ATSC, and enables Video On Demand (VOD) content files to be transmitted via a terrestrial broadcasting network. Such a technology is basically configured to divide a file into uniformly sized blocks, repeatedly transmit the blocks, and allow each receiver to receive and recombine the blocks.

However, when a receiver does not receive the blocks through a relevant channel by means of channel switching during the downloading of a file, or when reception errors occur during the reception of some blocks, the relevant receiver fails to completely download the entire file.

In order to increase the probability of success in downloading, files can be repeatedly transmitted over a broadcasting network. However, even if transmission is repeated an infinite number of times, it cannot be guaranteed that downloading has a 100% probability of success, and the amount of file contents that can be downloaded via the broadcasting network decreases as the number of repetitions increases.

### SUMMARY OF THE INVENTION

Accordingly, the present invention has been made keeping in mind the above problems occurring in the prior art, and an object of the present invention is to provide a method and apparatus for downloading files using both digital broadcasting and Internet-based transmission, which can efficiently download files over a broadcasting network.

In order to accomplish the above object, the present invention provides a method of downloading files using both digital broadcasting and Internet-based transmission, comprising dividing a file into uniformly sized blocks and transmitting the blocks via digital broadcasting, and in a case where blocks which failed to be received are present and retransmission of the blocks is required, if a specific block requiring retransmission must be retransmitted to a number of receivers which are equal to or greater than a predetermined number of receivers from among a total number of receivers, retransmitting the specific block via digital broadcasting, whereas if the specific block must be retransmitted to a number of receivers which are less than the predetermined number of receivers, retransmitting the specific block over an Internet.

Further, the present invention provides an apparatus for downloading files using both digital broadcasting and Internet-based transmission, comprising a digital broadcasting file download server for dividing a file to be transmitted into uniformly sized blocks and transmitting the blocks via a digital broadcasting network, and an Internet file download server for transmitting relevant blocks which failed to be received from among the blocks transmitted by the digital broadcasting file download server, over an Internet, wherein the Internet file download server receives a list of blocks to be retransmitted due to an abnormality which took place regarding the blocks received by at least one receiver, from the receiver, and wherein the Internet file download server is operated such that, if a specific block must be retransmitted to a number of receivers which are equal to or greater than a predetermined number of receivers from among a total number of receivers, the Internet file download server notifies the digital broadcasting file download server of the specific block thereby causing the digital broadcasting file download server to retransmit the specific block, whereas if the specific block must be retransmitted to a number of receivers which are less than the predetermined number of receivers from among the total number of receivers, the Internet file download server itself retransmits the specific block over the Internet.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a digital broadcasting system for a file download method according to the present invention;

FIG. 2 is a flowchart showing the operation of a digital broadcasting file download server;

FIG. 3 is a flowchart showing the operation of an Internet file download server; and

FIG. 4 is a flowchart showing the operation of a digital broadcasting receiver.

### DESCRIPTION OF THE PREFERRED EMBODIMENTS

Hereinafter, embodiments of the present invention will be described in detail with reference to the attached drawings.

The present invention relates to a method and apparatus for efficiently retransmitting the parts of a file which failed to be received over both a broadcasting network and the Internet when reception errors occur in some receivers during the downloading of the file performed via digital broadcasting.

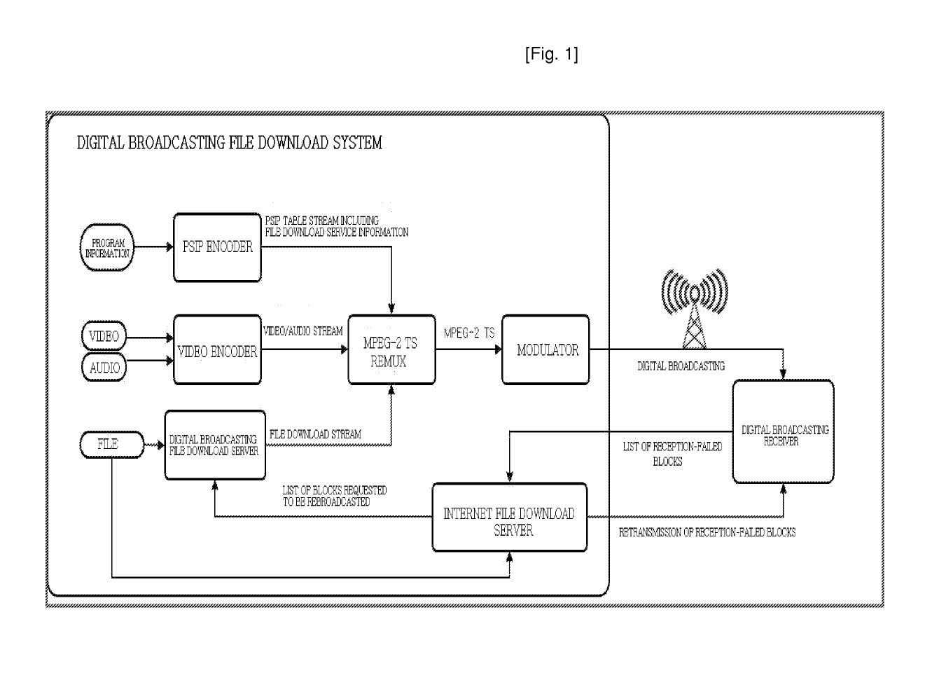

FIG. 1 is a diagram showing a digital broadcasting file download system according to an embodiment of the present invention. As shown in FIG. 1, the digital broadcasting file download system includes a digital broadcasting file download server for transmitting file data over a digital broadcasting network, an Internet file download server for transmitting file data over the Internet, and a digital broadcasting receiver for receiving the file data over the digital broadcasting network and the Internet and storing the file data.

A Program and System Information Protocol (PSIP) encoder, a video encoder, a Moving Picture Experts Group (MPEG)-2 Transport Stream (TS) Re-multiplexer (remux), and a modulator are devices for digital broadcasting and are identical to those of the related art, and thus a detailed description thereof will be omitted.

A method of operating the individual components will be described below.

1. When a file to be downloaded is prepared, each of the digital broadcasting file download server and the Internet file download server divides the file into blocks of the same size, and stores the blocks.

2. The digital broadcasting file download server broadcasts the received file once in the order of the first block to the last block of the file over a terrestrial broadcasting network.

In the case of terrestrial broadcasting, the file can be downloaded in conformity with the ATSC Software Download Data Service (SDDS) standard, the ATSC Non-Real Time (NRT) standard, etc.

3. When the primary broadcasting of the file over the digital broadcasting network has been completed, each receiver determines whether all blocks constituting the file have been successfully received. If it is determined that all blocks have been successfully received, the file is reconstructed using those blocks.

If it is determined that any blocks which failed to be received are present, each receiver transmits a list of the reception-failed blocks to the Internet file download server over the Internet.

4. The Internet file download server receives the list of reception-failed blocks from each receiver and checks the number of receivers which failed to receive each of the reception-failed blocks.

When the number of receivers failed to receive each block is equal to or greater than a predetermined number, the Internet file download server generates a list of relevant blocks, and transfers the list to the digital broadcasting file download server, thus requesting retransmission via digital broadcasting from the digital broadcasting file download server. The digital broadcasting file download server retransmits the blocks belonging to the list received from the Internet file download server via terrestrial broadcasting.

When the number of receivers which failed to receive each block is less than the predetermined number, the Internet file download server transmits the relevant blocks to corresponding receivers over the Internet.

5. Each receiver receives and stores the blocks retransmitted via terrestrial broadcasting and the blocks transmitted over the Internet. The receiver determines again whether all blocks constituting the file have been successfully received. If it is determined that all blocks have been successfully received, the file is reconstructed using the blocks.

If it is determined that any blocks which failed to be received are present, the receiver transmits a list of reception-failed blocks to the Internet file download server over the Internet.

6. The fourth and fifth procedures are repeated until the downloading of the file has been completed by all the receivers.

Hereinafter, the operation of the individual components of the system will be described in detail.

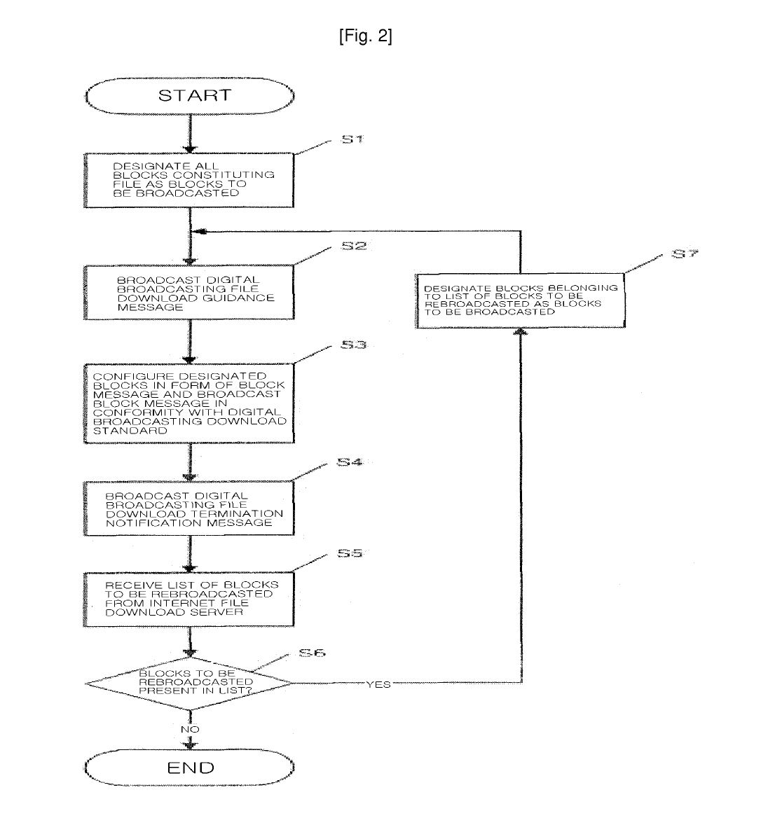

FIG. 2 is a flowchart showing the operation of the digital broadcasting file download server.

First, when there is a file to be transmitted, the digital broadcasting file download server divides the file into uniformly sized blocks and designates the individual blocks as blocks to be broadcasted at step S1.

Before the file is transmitted over a broadcasting network, a download guidance message is broadcasted to allow individual receivers to prepare for the reception of the file at step S2.

The designated blocks are transmitted in conformity with the download standard of digital broadcasting over the broadcasting network at step S3. For this transmission, the typical broadcasting devices of FIG. 1 are driven and then transmit the file.

When all of the designated blocks are transmitted, a download termination notification message is broadcasted at step S4.

Further, the digital broadcasting file download server receives a list of blocks to be rebroadcasted (or retransmitted) from the Internet file download server at step S5. A digital broadcasting receiver which has received blocks according to the above process summarizes blocks which have not been received, blocks which have been received but were not normally received due to the occurrence of errors during the transmission of the blocks, creates a list of reception-failed blocks, and transmits the list of reception-failed blocks to the Internet file download server. When each digital broadcasting receiver transmits a list of reception-failed blocks to the Internet file download server, the Internet file download server, having received the list from each digital broadcasting receiver, determines whether to transmit individual blocks in the reception-failed block list over the broadcasting network or over the Internet. That is, when, for a specific block, a number of digital broadcasting receivers equal to or greater than a predetermined number did not receive the specific block, or did not normally receive the specific block, the specific block is added to the list of blocks to be rebroadcasted. Such a list of blocks to be rebroadcasted is used to rebroadcast relevant blocks over the broadcasting network. The Internet file download server transmits the list of blocks to be rebroadcasted to the digital broadcasting file download server.

The digital broadcasting file download server determines whether any blocks to be rebroadcasted are present by examining the received list of blocks to be rebroadcasted at step S6.

If it is determined that there is no block to be rebroadcasted, the above process is terminated, whereas if it is determined that there are blocks to be rebroadcasted, the blocks included in the list are designated as blocks to be broadcasted at step S7.

Further, the process including steps S2 to S5 is repeated until there is no longer any block to be rebroadcasted.

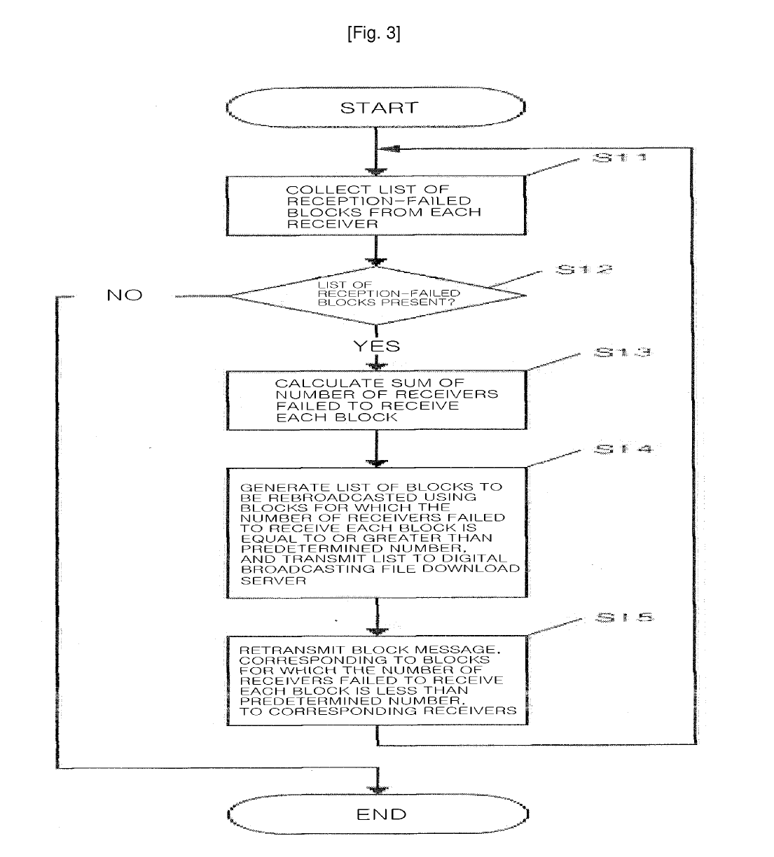

The operation of the Internet file download server will be described below. FIG. 3 is a flowchart showing the operation thereof.

First, the Internet file download server collects a list of reception-failed blocks from each receiver at step S11, and determines whether a list of reception-failed blocks is present at step S12.

If it is determined that there is not a list of reception-failed blocks, the process is terminated, whereas if it is determined that there is a list of reception-failed blocks, the sum of the number of receivers which failed to receive each of the blocks is calculated at step S13.

Further, when the number of receivers which failed to receive each of the blocks is equal to or greater than a predetermined number, the Internet file download server generates, using those blocks, a list of blocks to be rebroadcasted and transmits the list to the digital broadcasting file download server at step S14.

Further, when the number of receivers which failed to receive each block is less than the predetermined number, the Internet file download server transmits the block to relevant receivers at step S15.

That is, at steps S13 to S15, when there are a large number of receivers which failed to receive a specific block, the specific block needs to be transmitted in large quantities, and is then retransmitted over the broadcasting network enabling large-capacity transmission. Further, when there are a small number of receivers which failed to receive a specific block, the relevant file is transmitted over the Internet, so that the Internet is used as an auxiliary network, thus improving transmission efficiency.

Further, the process including steps S11 to S15 is repeated until the list of reception-failed blocks is empty.

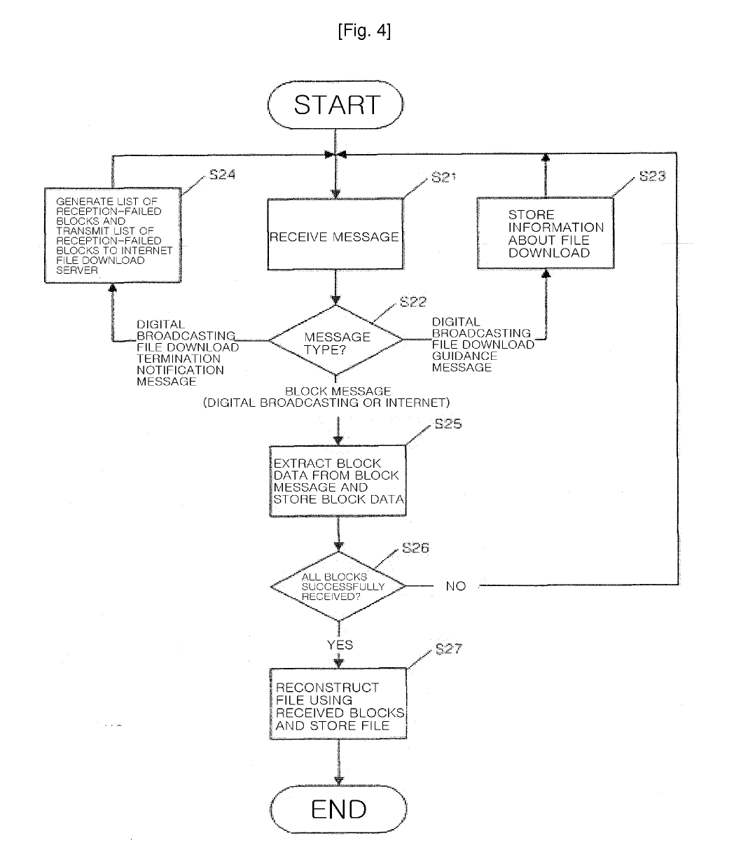

Next, the operation of the digital broadcasting receiver will be described. The flowchart showing the operation thereof is shown in FIG. 4.

First, the receiver receives a message at step S21. When receiving the message, the receiver determines the type of message at step S22.

When the received message is a digital broadcasting file download guidance message, the receiver stores information about file download at step S23.

Further, when the received message is a digital broadcasting file download termination notification message, the receiver examines received blocks, generates a list of reception-failed blocks, and transmits the list to the Internet file download server at step S24.

Furthermore, when the received message is a block message, that is, a message related to the block of the file received via digital broadcasting or over the Internet, the receiver extracts the block from the message and stores the extracted block at step S25.

In this case, all of the process is repeated until the receiver successfully receives all of the blocks at step S26.

In addition, when the receiver succesfully receives all of the blocks, the receiver reconstructs the file using the received blocks, and thus restores the reconstructed file to the original file and stores the original file at step S27.

As described above, the largest part of a file is downloaded to a receiver via digital broadcasting which is a one-way medium, and the part of the file which has not been received is transmitted over the Internet which is an interactive medium, thus enabling a large-capacity file to be simultaneously and reliably transmitted to from several hundreds to several tens of millions of receivers.

Further, since the largest part of a file is transmitted over a terrestrial broadcasting network, the expenses related to the use of Internet lines can be greatly reduced. Furthermore, since the part of the file which was not received is transmitted over the Internet, the failure of transmission using terrestrial broadcasting which is a one-way medium can be solved, thus guaranteeing the reliability of reception. Since the part of the file which has not been received can be transmitted over the Internet, there are advantages in that the number of repetitive transmissions using terrestrial waves can be reduced, and thus a larger number of files can be transmitted for the same period of time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

This application claims the benefit and priority of Korean Patent Application No. 10-2009-0111159, filed Nov. 17, 2009. The entire disclosure of the above application is incorporated herein by reference.

What is claimed is:

1. A method of downloading files using both digital broadcasting and Internet-based transmission, comprising:
dividing a file into uniformly sized blocks and transmitting the blocks via digital broadcasting; and
in a case where blocks which failed to be received are present and retransmission of the blocks is required, if a specific block requiring retransmission must be retransmitted to a number of receivers which are equal to or greater than a predetermined number of receivers from among a total number of receivers, retransmitting the specific block via digital broadcasting, whereas if the specific block must be retransmitted to a number of receivers which are less than the predetermined number of receivers, retransmitting the specific block over an Internet.

2. An apparatus for downloading files using both digital broadcasting and Internet-based transmission, comprising:
a digital broadcasting file download server for dividing a file to be transmitted into uniformly sized blocks and transmitting the blocks via a digital broadcasting network; and
an Internet file download server for transmitting relevant blocks which failed to be received from among the blocks transmitted by the digital broadcasting file download server, over an Internet,
wherein the Internet file download server receives a list of blocks to be retransmitted due to an abnormality which took place regarding the blocks received by at least one receiver, from the receiver, and
wherein the Internet file download server is operated such that, if a specific block must be retransmitted to a number of receivers which are equal to or greater than a predetermined number of receivers from among a total number of receivers, the Internet file download server notifies the digital broadcasting file download server of the specific block thereby causing the digital broadcasting file download server to retransmit the specific block, whereas if the specific block must be retransmitted to a number of receivers which are less than the predetermined number of receivers from among the total number of receivers, the Internet file download server itself retransmits the specific block over the Internet.
